(19) United States
(12) Patent Application Publication
(10) Pub. No.: US 2023/0324571 A1
(43) Pub. Date: Oct. 12, 2023

(54) GEM SYSTEM, APPARATUS, AND METHOD FOR TRACKING COSMIC RAY MUONS

(71) Applicant: Ideon Technologies Inc., Richmond (CA)

(72) Inventor: Douglas William SCHOUTEN, Surrey (CA)

(21) Appl. No.: 18/306,180

(22) Filed: Apr. 24, 2023

Related U.S. Application Data
(63) Continuation of application No. PCT/CA2021/051509, filed on Oct. 26, 2021.
(60) Provisional application No. 63/105,811, filed on Oct. 26, 2020.

(51) Int. Cl. G01T 1/29; H01J 43/06

(52) U.S. Cl. CPC G01T 1/2935; G01T 1/2985; H01J 43/06

(57) ABSTRACT

A gas electron multiplier (GEM), used to track cosmic ray muons, can have readout electrodes oriented in a helical pattern so that it can fit inside a narrow aperture borehole. The helical orientation of the readout electrodes provides for high spatial resolution and yet is cost effective to manufacture. The GEM can have an insulation layer, a plurality of conduction layers and an inner layer comprising a plurality of helical conductive stripes extending between two ends of the GEM.

### REFERENCE TO RELATED APPLICATIONS

This application is a continuation of Patent Cooperation Treaty (PCT) application No. PCT/CA2021/051509 having an international filing date of 26 Oct. 2021 which in turn claims priority from, and for the purposes of the United States, the benefit under 35 USC 119 in relation to U.S. application No. 63/105,811 filed 26 Oct. 2020. All of the applications referred to in this paragraph are hereby incorporated herein by reference.

### INTRODUCTION

This device relates generally to an apparatus for tracking cosmic ray muons through an underground sensor to develop an image of subsurface density above the sensor (muon radiography), and to use multiple sensors to build a 3D model of density (muon tomography).

### TECHNICAL FIELD

The present invention relates to a gas electron multiplier (GEM) and, to a cylindrical GEM using the interaction between radiation and gas, as well as a radiation detector using multiple, concentric cylindrical GEMs.

### BACKGROUND

Exploitation of underground resources (e.g., mineral deposits, oil reservoirs) employs varied geophysical methods to detect, image, and monitor underground regions of interest. Many of the devices and systems used are large. There are numerous designs of borehole detectors. To be useful, a borehole detector that fits inside a very narrow aperture borehole (e.g., a NQ diamond drill bore, 76 mm diameter) must have very good spatial resolution for detecting the location of a muon at various points as it passes through the sensor. This is because the “lever arm” of the detector is very small, less than a few centimeters in total if the detector enclosure thickness and gap to the borehole is considered. What is needed then is a muon detector with very fine spatial resolution.

The muon detector must also be cost-effective. Very expensive systems e.g., such as those based on silicon pixel technology, are not amenable to deployment down drill holes where there is a high probability of losing the detector due to deformation of the hole.

A type of gaseous avalanche electron multipliers for the detection of ionising radiation are often referred to as Gas Electron Multipliers detectors. GEM detectors have been extensively used in high energy physics experiments such as hadron colliders. They represent a significant improvement over conventional detectors such as multi-wire proportional counters.

Conventional GEMs have been used to detect radiation, such as charged particles, gamma rays, and neutrons. When the radiation, which is the detection target, enters such a GEM, it uses electron avalanche effects to multiply electrons released from gas atoms because of the interaction between radiation and a gas and enables to detect the radiation as an electrical signal.

GEM detectors and systems have two electrodes that consist of two thin sheets of conductive material that are overlain on both sides of a polymer foil. An etching method develops narrow regularly spaced holes through both conductive sheets and the middle polymer layer. The conductive sheets are held at different electrical potentials, with a difference of a few 10's to 100's of volts. The very narrow gap between the sheets then creates a very strong electric field that is mostly axial within the etched holes.

A GEM detector has a drift region with an ionizing gas. A charged particle passing through the drift region liberates some electrons from the ionizing gas. The liberated electrons then drift towards the electrode leaving an ionization trail. As some of the electrons pass through the gap between the conductive sheets, they are accelerated greatly by the very large electric field and generate further ionization in the gas and thus a large enhancement in the drift current (an electron avalanche).

A GEM detector has an induction region between GEM layers or between the last GEM layer and the sense PCB. In this last induction region, the macroscopic electrical current induces a mirror current on the pickup wires at the bottom of the induction region, which is how the passage of charged particles is then ultimately measured. Multiple layers of GEM electrodes create multiplicative growth in the “gain” of current from the very few ionization electrons liberated in the drift region.

A GEM detector device has pairs of orthogonal readout electrodes that are used to measure the location of the ionization trail. The device has orthogonal sets of X and Y coordinate strips along its axes. By interpolating the measured current across neighbouring sets of X and Y coordinate strips, the absolute position of a charged particle when it passed through the plane can be determined with sub-millimeter precision.

Multi-layer GEM detectors in planar and other configurations have been used to detect radiation in particle collider beamlines.

### BRIEF DESCRIPTION OF THE FIGURES

FIG. 1 shows electric field lines in a GEM electrode.

FIG. 2 shows a single GEM layer with an X-Y readout.

FIG. 3 shows a front isometric view of a cylindrical GEM apparatus.

FIG. 4 is a close-up view of the apparatus used in association with a housing.

FIG. 5 shows a close-up view of the apparatus of FIG. 3,

FIG. 6 shows a top view of the apparatus of FIG. 3.

FIG. 7 shows a side view of the apparatus of FIG. 3.

FIG. 8 shows an exploded side view of the apparatus of FIG. 3, with the outer conductive layer removed.

FIG. 9 shows an exploded side view of the apparatus of FIG. 3, with the outer conductive layer and the insulating layer removed.

FIG. 10 shows an exploded side view of the helically wound conductive strips, in accordance with an embodiment of the apparatus of FIG. 3,

FIG. 11 shows a close-up view of the intersection points of the helically wound conductive strips.

FIGS. 12-14 are partial, cut-away views of an embodiment of the apparatus of FIG. 7.

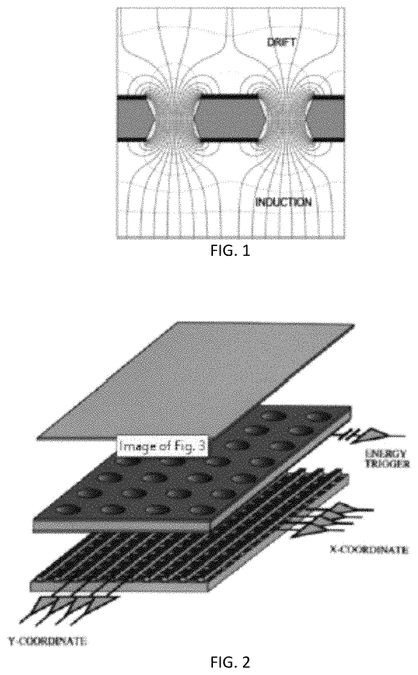

### DETAILED DESCRIPTION

An embodiment for a cylindrical apparatus for detecting cosmic ray muons using gas electron multiplier (GEM) technology where readout electrodes are oriented in a helical pattern around the apparatus is disclosed. The apparatus is relatively inexpensive to manufacture, affords very high spatial resolution, and can be fit inside a narrow aperture borehole.

The GEM detector is composed of one or more, concentric, coaxial, cylindrical GEM tracking layers. Each GEM layer has two conductive layers 20, 30, and an insulating layer 10 between the two conductive layers. Each layer has perforations that are coaligned among the layers. The three layers with perforations 75 are collectively a foil. Typically, the diameter of each perforation 75 is similar to the thickness of the layers.

In an embodiment, the GEM detector has one concentric cylindrical triple-GEM tracking layers, where each layer has a total active length of 300 cm (comprised of multiple segments of 50 cm stacked together).

The anode plane of the detector is a multi-layer kapton/copper flexible circuit with helical clockwise and counter-clockwise strips. In an embodiment, the GEM detector may be operated with an approximate Ar:C4H10 90:10 gas mixture.

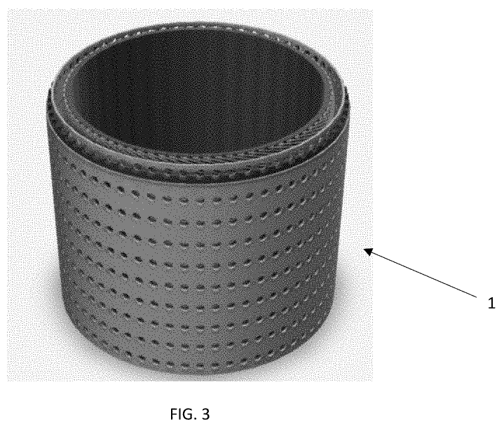

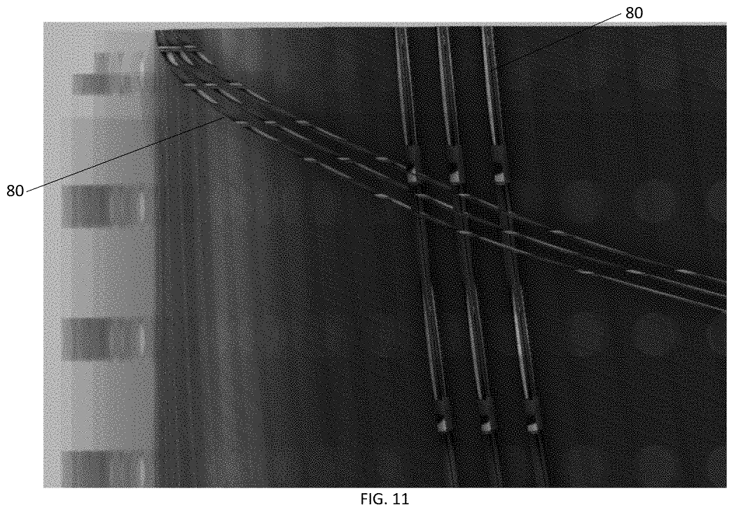

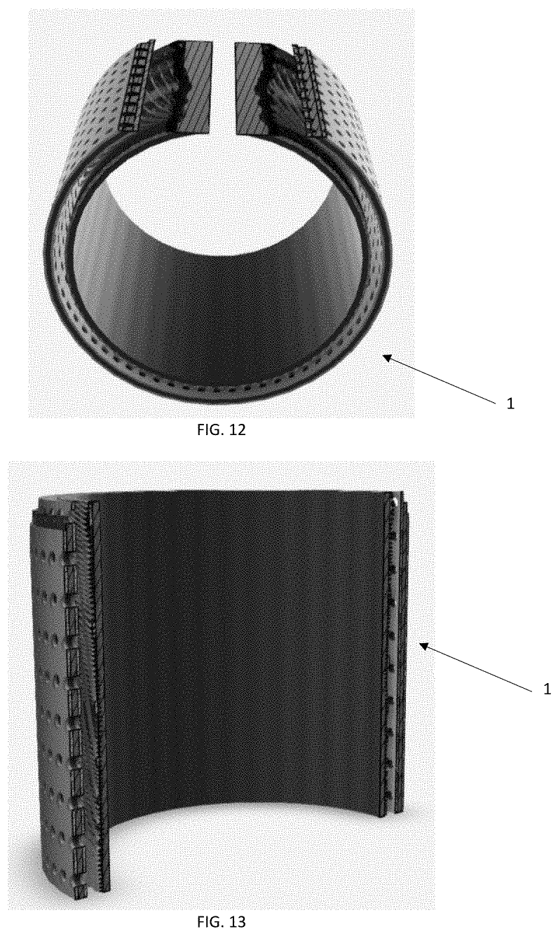

FIGS. 3-19 show an embodiment of a cylindrical GEM apparatus 1 having several, cylindrical, concentric layers.

In an embodiment the apparatus 1 has one GEM layer and helically wound conductive strips for readout of the amplified ionization current. The apparatus has an insulating medium 10, inner and outer conductive layers 20, 30 surrounding the insulating medium 10, and an inner layer 50 having readout electrodes 60 on an inner printed circuit board (PCB) 70. The conductive layers have perforations 75 in them for amplification of the ionization charge. In this Figure the perforations 75 are exaggerated for illustration purposes. They are typically closely spaced and have small diameter such that the GEM layer resembles a mesh foil that is only partially opaque.

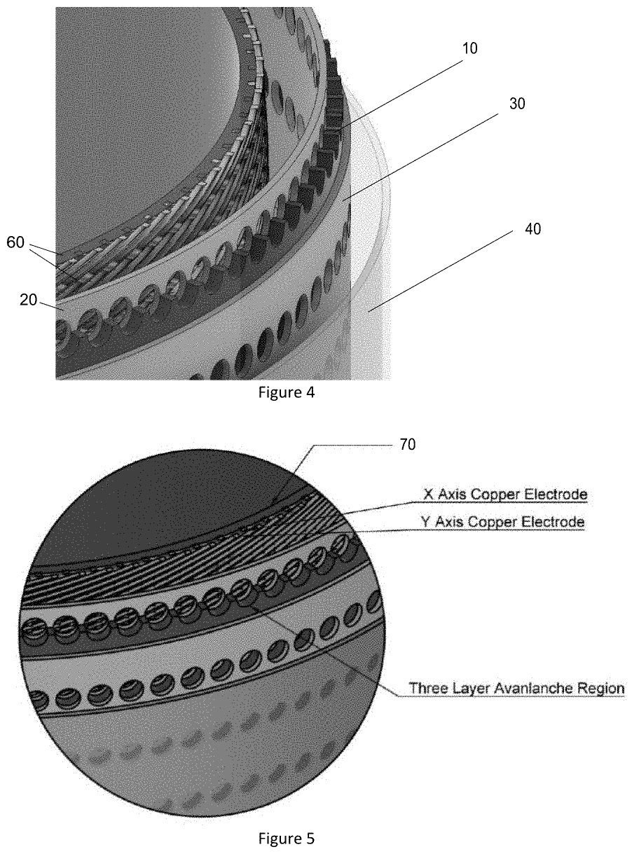

FIGS. 4 and 5 are close-up views of the apparatus 1. FIG. 40 shows the apparatus within an enclosure 40. The inner layer 50 of the apparatus has a PCB and readout electrodes 60 in surface of the PCB 70. The electrodes 60 may be made of any conductive material, such as copper. In an embodiment, the apparatus has two sets of electrodes 60 that extend along the clockwise and counter-clockwise cylindrical axes, respectively. A cylindrical shaped inner conductive layer (at − potential) surrounds the inner layer 50. An insulating layer 10 surrounds the inner conductive layer 20. A cylindrical shaped outer conductive layer 30 (at + potential) surrounds the inner layer 50. The cylindrical housing enshrouds the apparatus.

When in use, an electron avalanche forms in the region between the conductive layers, within the perforations (holes) of the insulating layer.

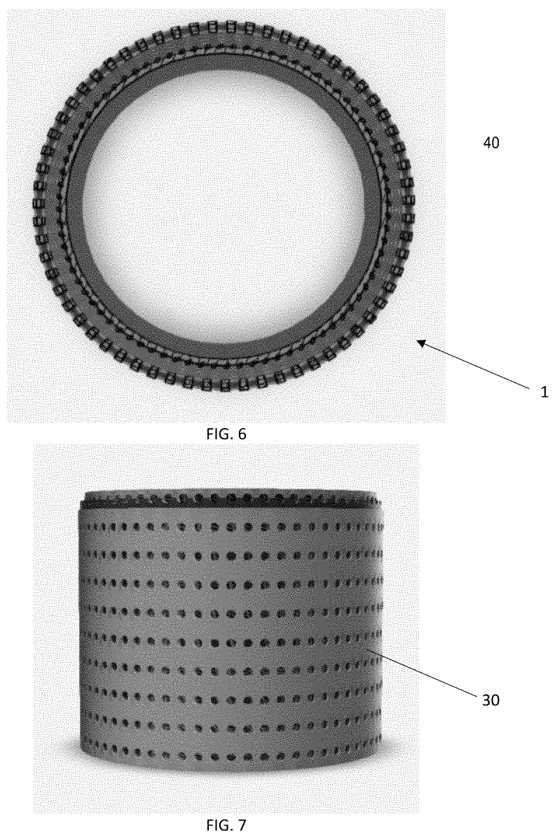

FIG. 6 shows a top view of the apparatus in accordance with an embodiment of the apparatus of FIG. 3. In an embodiment, the apparatus has an insulating layer between conductive layers 20, 30.

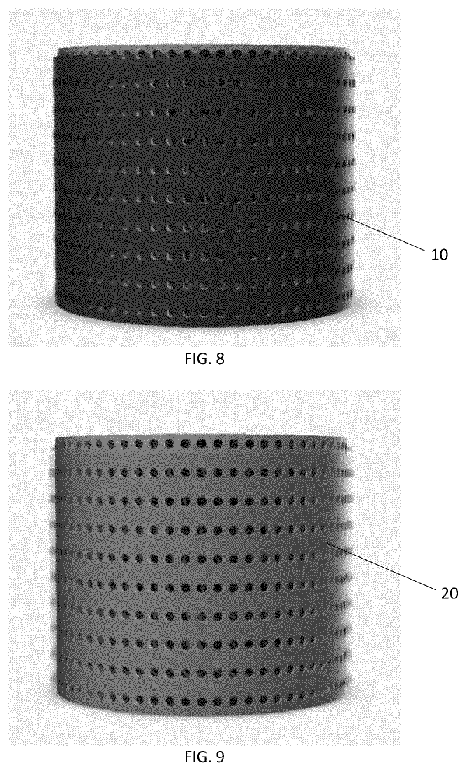

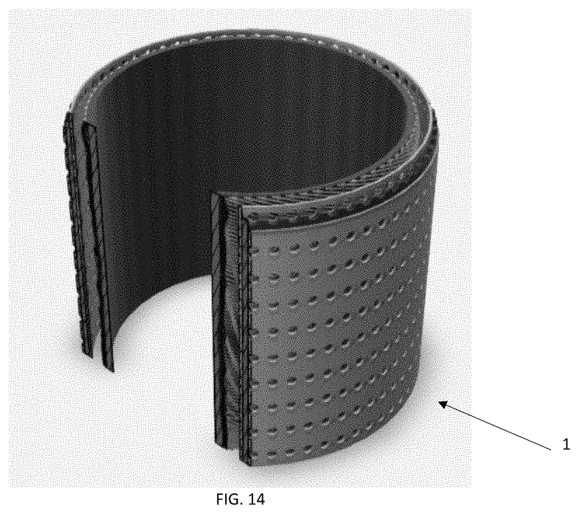

FIGS. 7-9 show exploded side views of the apparatus of FIG. 3. FIG. 7 shows the outer conductive layer 30 with perforations 75. FIG. 8 shows the insulating layer. With perforations 75. FIG. 9 shows the inner conductive layer with perforations 75. FIG. 14 shows the inner layer 50 with readout electrodes 60 on an inner printed circuit board (PCB) 70.

In an embodiment, the printed circuit board 70 has one or more layers of conductive strips 80 that are wrapped helically, clockwise and counter-clockwise, around the cylindrical body of the inner layer from the bottom to the top of the apparatus in a helical configuration. In an embodiment, the PCB has two layers of conductive strips that are wrapped exactly once around the cylinder between the two surfaces of the device. The two layers of conductive strips on the PCB are electrically isolated from one another. In an embodiment the PCB is constructed with a flexible material.

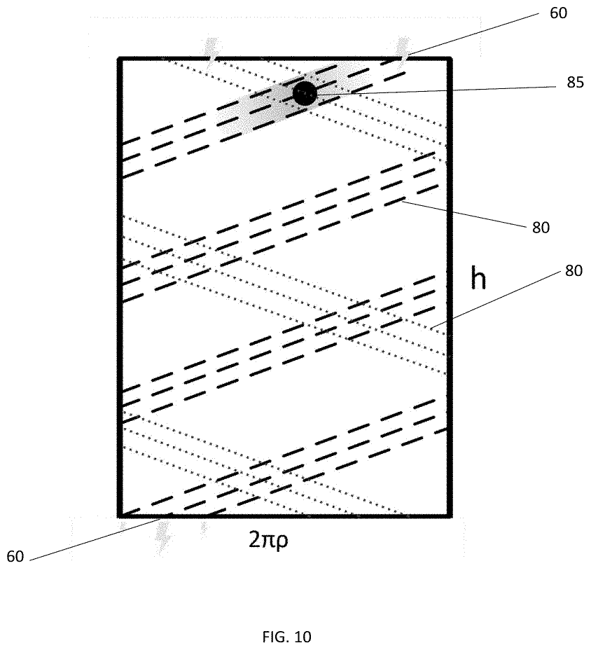

FIG. 10 shows an embodiment of the apparatus where one layer having three wires is wound in a clockwise helix (dark, dashed lines) and the other layer (small, faint dots) having three wires is wound in a counter-clockwise helix around the cylindrical apparatus. The embodiment of FIG. 10 shows two sets of pickup wires, one from each of two counter-clockwise wound helices.

Referring to FIG. 10, when the ionization, induced by a passing muon, impacts near a wire (strip), a pulse of current is created on the strip at the impact point. The pulse then travels to both ends of the wire. If the muon impacts near the mid-point of the total pickup wire length, the electrical pulse will arrive at both ends of the wire at approximately the same time and the voltage associated with the pulse's current will be approximately the same at both ends. However, if the muon does not impact near the mid-point of the pickup wire (e.g., the impact point is closer to one end of the wire than the other), the electrical pulse will arrive at both ends of the wire at different times and the voltage associated with each pulse's current will be different (because the voltage diminishes as the pulse travels along length of the wire, away from the impact point, and toward the end of the wire due to the resistive nature of the wire).

Supposing that there are m windings in the clockwise and n windings in the counter-clockwise direction (m=4, n=3 in FIG. 10), then if m and n have no common factors, there is an (m+n)-fold ambiguity of crossing positions where a muon could have crossed through in order to initiate an electron avalanche in the GEM layer and thereby voltage in sets of pickup wires (the measured voltage is indicated by the charge icons, and in this case is measured on both sides of one of the groups and only one side of the other) from the clockwise and counterclockwise oriented sets.

These (m+n) possible locations are resolved by using the two-sided measurement to determine where along the set of pickup wires the muon-initiated electron avalanche induced a mirror current. This provides an additional measurement with associated uncertainty indicated by the gradient band. If the uncertainty is narrower than the pitch between the (m+n) possible solutions, then the actual position at which the muon impacts one side of the cylindrical apparatus (the black dot) is uniquely determined.

During operation, a data acquisition system “reads out”, or measures the current pulse characteristics (e.g., voltage and time) to determine the impact location of a muon-induced electron avalanche along a pickup wire.

The conductive strips 80 are read out at one or both ends of the detector. In the case of double-sided readout, the relative charge—based on the resistive properties of the strips—and/or relative timing information for readouts on both ends can be further used to interpolate the position of the induced signal from a charged particle along a particular strip.

In an embodiment, the apparatus has the helix windings >1 for each helix, and the ambiguity of multiple crossings is resolved using the relative charge and/or timing measurements from both ends of each strip.

Charged particles (such as muons) passing through the ionizing gas liberate electrons which drift towards the GEM layer. Large electron multiplication (electron avalanche) occurs in the 1 or more GEM layers. This avalanche drifts towards the conductive strips on the printed circuit board which are held at a lower potential. The drift current induces a fast response on the readout strips, which can be digitized. By measuring the voltage response on multiple neighbouring strips within any one of the helical bundles, an average position of the pulse across those strips may be interpolated. Then, the intersection of the average strip between the counter wound helices provides a spatial position measurement for where a charged particle (muon) trajectory pierced the cylinder wall. Since the positions of the strips and the system geometry is known, these yield fully 3D space point measurements on piercing the wall of the detector at entry and exit for each charged particle that passes through the detector. The (minimally) two space points provide a straight-line trajectory that can be used to generate a radiographic intensity image, which can be combined from multiple other such sensors to perform muon tomographic analysis.

FIGS. 3-6, 13-14 show the perforated GEM structures on both sides of an insulating medium. The apparatus may have one or more of these layers.

### LIST OF FEATURES

1 apparatus
10 insulating medium
20 inner conductive layer
30 outer conductive layer
40 enclosure
50 inner layer of the apparatus
60 read out electrodes
70 printed circuit board (PCB)
75 perforations
80 conductive strips
85 muon

1. A narrow cylindrical GEM detector apparatus for detecting muons, the apparatus comprising:
an insulation layer;
a plurality of conduction layers; and
an inner layer comprising a plurality of helical conductive strips extending between the two ends of the detector.

2. The apparatus of claim 1, further comprising a housing.

3. The apparatus of claim 2, wherein the housing comprises a cylindrical shape.

4. The apparatus of claim 1, wherein the GEM detector consists of multiple longitudinal segments connected together via interconnects.

5. The apparatus of claim 1, wherein the GEM layer is comprised of semi-circular halves.

6. The apparatus of claim 1, wherein the helical conductive strips extend along the length of the apparatus.

7. The apparatus of claim 1, wherein the helical conductive strips extend both in clock-wise and counter clock-wise directions along the length of the apparatus.

8. A method of using the apparatus of claim 1 to detect muons in a borehole, the method comprising:
providing the apparatus of claim 1;
installing a GEM detector apparatus within a suitable environmental enclosure into a borehole
collecting the signals from the detector readout consisting of time and pulse height for each current pulse measured on the pickup wires;
filtering the set of signals by selecting only those for which a prescribed number of signals are measured within a predefined time window consistent with the passage of an energetic charged particle through the detector;
collecting the grouped signals into candidate events;
interpolating the signal in the candidate events to reconstruct the positions of a charged particle as it pierces the GEM layers of the detector on entry and exit;
using linear regression or other reasonable interpolation method (such as curvilinear fit in the presence of magnetic fields, or accounting for multiple scattering for low energy particles) to determine the trajectory (two angles and an origin) of the charged particle (muon) from the known geometry and position of the detector and the interpolated positions of entry and exit;
populating radiographic image with the observed rate of muons impinging upon the detector from all angles within some defined field of view;
populating radiographic image with the observed rate of muons impinging upon the detector at a given position on the detector from all angles within some defined field of view; and
using the radiographic images to infer the average density of the medium in all directions within some defined field of view.

9. A GEM detector apparatus comprising:
an insulation layer;
a plurality of conduction layers;
an inner layer comprising a plurality of helical conductive strips extending between the two ends of the detector.

10. A detection system comprising:
a GEM detector comprising a plurality of helical conductive strips extending between the two ends of the detector; and
a data acquisition system for acquiring information from the GEM detector.
